(19) United States
(12) Patent Application Publication
(10) Pub. No.: US 2026/0022271 A1
(43) Pub. Date: Jan. 22, 2026

(54) COATING AGENT COMPOSITION

(71) Applicant: THREEBOND CO., LTD., Tokyo (JP)

(72) Inventors: Hisanori IMAOKA, Tokyo (JP); Manabu KIRINO, Tokyo (JP)

(21) Appl. No.: 19/115,883

(22) PCT Filed: Oct. 3, 2023
(86) PCT No.: PCT/JP2023/036094

§ 371 Date: Mar. 27, 2025

(30) Foreign Application Priority Data
Oct. 7, 2022 (JP) 2022-162524

(51) Int. Cl. C09D 183/06; C08G 77/08; C08G 77/18; C08G 77/28; C09D 7/20

(52) U.S. Cl. CPC C09D 183/06; C08G 77/08; C08G 77/18; C08G 77/28; C09D 7/20; C08G 2150/00; C08G 2170/00

(57) ABSTRACT

A coating agent composition includes the following components (A) to (D). Component (A) is a silicone oligomer having only an alkoxy group, a phenyl group and an alkyl group in its molecule. component (B) is a compound having an alkoxy group and having an amino group and/or a mercapto group in its molecule. Component (C) is a silicone oligomer having only an alkoxy group and an alkyl group in its molecule. Component (D) is a curing catalyst.

### TECHNICAL FIELD

The present invention relates to a coating agent composition.

### BACKGROUND ART

A problem in outdoor installation objects often installed outdoor, such as signboards and automatic vending machines, has been that exposure of such outdoor installation objects to rain and wind leads to scratching of main bodies, thereby causing such outdoor installation objects to be lost in design and/or be corroded through scratched portions. While procedures for polishing with compounds or painting with the same colors are performed for the disappearance of such scratches, these procedures require a high level of skill from the technicians. Thus, outdoor installation objects once scratched are difficult to repair, and therefore a method is known in which a coating agent is used in advance so as to allow a main body to be hardly scratched (Patent Literature 1, Patent Literature 2).

### CITATION LIST

### Patent Literature

Patent Literature 1: JP 2007-161989 A
Patent Literature 2: JP 2015-183014 A

### SUMMARY OF INVENTION

However, even in the case of coating with a coating agent in advance, a problem is that peeling or cracking of the coating agent may occur by strong impact due to the outdoor and/or such cracking may impair the design of an outdoor installation object. Also in the case of coating with a coating agent after an outdoor installation object is scratched, a problem is that such a scratch cannot be covered and design is impaired.

Accordingly, an object of the present invention is to provide a coating agent composition which can allow a cured product thereof to cover a scratch and which is excellent in adhesiveness.

The present inventors have made intensive studies in order to achieve the above object, and as a result, have found a solution relating to a coating agent composition which is excellent in design and also excellent in adhesiveness because, even if an outdoor installation object is scratched, such a scratch can be coated and thus covered, leading to completion of the present invention.

Next, the gist of the present invention is described.

[1] A coating agent composition comprising the following components (A) to (D):
component (A): a silicone oligomer having only an alkoxy group, a phenyl group and an alkyl group in its molecule;
component (B): a compound having an alkoxy group and having an amino group and/or a mercapto group in its molecule;
component (C): a silicone oligomer having only an alkoxy group and an alkyl group in its molecule; and
component (D): a curing catalyst.

[2] The coating agent composition according to [1], wherein the alkyl group in the component (A) is a methyl group.

[3] The coating agent composition according to [1] or [2], wherein the alkoxy group in the component (A) is a methoxy group.

[4] The coating agent composition according to [1] to [3], wherein the component (B) is a silicone oligomer having an alkoxy group and having an amino group and/or a mercapto group in its molecule.

[5] The coating agent composition according to [1] to [4], wherein a content of the component (B) is 0.1 to 15 parts by mass based on 100 parts by mass of the component (A).

[6] The coating agent composition according to [1] to [5], wherein a content of the component (C) is 0.1 to 15 parts by mass based on 100 parts by mass of the component (A).

[7] The coating agent composition according to [1] to [6], wherein the component (D) is metal alkoxide.

[8] The coating agent composition according to [1] to [7], further comprising an organic solvent.

[9] An outdoor installation object coated with a cured product of the coating agent composition according to [1] to [8].

The present invention provides a coating agent composition, in particular, a coating agent composition for outdoor use, which can allow a cured product thereof to cover a scratch and which is excellent in adhesiveness. The present invention also provides a coating agent composition in which, even if a cured product thereof is subjected to impact, peeling or cracking of the cured product hardly occurs. The present invention further provides a coating agent composition in which a cured product thereof is excellent in bending resistance and weather resistance.

### DESCRIPTION OF EMBODIMENTS

Next, the detail of the present invention is described. The present invention is not limited to only the following embodiments. Unless particularly noted, operations and measurement of physical properties and the like are herein performed in conditions of a room temperature (20° C. or more and 25° C. or less) and a relative humidity of 40% RH or more and 50% RH or less. In addition, “A and/or B” encompasses each of A and B, and any combination of one or more thereof, and specifically means at least one of A and B, or means A, B, and a combination of A and B. Herein, “X to Y” is used to mean inclusion of numerical values (X and Y) described before and after “to” respectively as the lower limit value and the upper limit value, and means “X or more and Y or less”. In a case where “X to Y” is plurally designated, for example, “X1 to Y1 or X2 to Y2” is designated, all of the disclosure where each numerical value serves as the upper limit, the disclosure where each numerical value serves as the lower limit, and the disclosure where such upper limits-lower limits are combined are made (namely, contribute to legitimate evidences for amendment). Specifically, all of the amendment to X1 or more, the amendment to Y2 or less, the amendment to X1 or less, the amendment to Y2 or more, the amendment to X1 to X2, the amendment to X1 to Y2, and the like must be regarded as being legitimate.

In one aspect of the present invention, there is provided a coating agent composition including the following components (A) to (D): component (A): a silicone oligomer having only an alkoxy group, a phenyl group and an alkyl group in its molecule; component (B): a compound having an alkoxy group and having an amino group and/or a mercapto group in its molecule; component (C): a silicone oligomer having only an alkoxy group and an alkyl group in its molecule; and component (D): a curing catalyst. Thus, the coating agent composition of the present invention (herein, also simply referred to as “composition”) can be provided as a coating agent composition, in particular, a coating agent composition for outdoor use, which can allow a cured product obtained by curing the composition (herein, also simply referred to as “cured product”) to cover a scratch and which is excellent in adhesiveness.

Herein, the silicon oligomer having a functional group A refers to a silicon oligomer having a main chain backbone formed by a siloxane bond (Si—O—Si), and a functional group A present at a molecular chain end, in a side chain, or the like. The silicon oligomer having a functional group A is derived from a silane compound having a functional group A. Specifically, the silane compound having a functional group A has a hydrolyzable group bound to a silicon atom, thereby leading to progression of a hydrolysis and dehydration-condensation reaction, formation of a siloxane bond (Si—O—Si), and progression of oligomer formation of the silane compound having a functional group A, to provide a silicon oligomer having a functional group A at a molecular chain end, in a side chain, or the like. In one embodiment, the hydrolyzable group can be the above functional group A. The above functional group A may be constituted singly or in combinations of two or more thereof. In one embodiment, among hydrolyzable groups included in the silane compound, only some of such hydrolyzable groups are used for hydrolysis and such hydrolyzable groups remaining can remain in a silicon oligomer structure.

Herein, the silicon oligomer having only a functional group A refers to a silicon oligomer not only having a main chain backbone formed by a siloxane bond (Si—O—Si), but also certainly having only a functional group A at a molecular chain end, in a side chain, or the like. In one embodiment, the above functional group may be constituted singly or in combinations of two or more thereof.

Herein, the silicone oligomer having an alkoxy group refers to a silicon oligomer having a main chain backbone formed by a siloxane bond (Si—O—Si), and an alkoxy group at a molecular chain end, in a side chain, or the like. The silicon oligomer having an alkoxy group is a polymer which is obtained by partially hydrolyzing a silane compound having an alkoxy group by a known catalyst such as an acid, a base, an organotin compound, or an organotitanium compound, to perform partial hydrolytic condensation, and which is a silicone compound having an alkoxy group derived from the silane compound, at a molecular chain end, in a side chain, or the like and thus having a linear structure, a branched structure or a three-dimensional network structure.

Examples of a preferred mode of the silane compound having an alkoxy group, for providing the silicone oligomer, include polyfunctional alkoxysilane compounds such as a dialkoxysilane compound, a trialkoxysilane compound and a tetraalkoxysilane compound, and monoalkoxysilane compounds (monofunctional alkoxysilane compounds). In other words, the silicone oligomer is preferably a partial hydrolytic condensate of an alkoxysilane compound represented by the following formula (1). The alkoxysilane compound represented by the following formula (1) may be used singly or in combinations of two or more kinds thereof. The silicone oligomer may be used singly or in combinations of two or more kinds thereof.

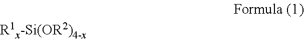

In the formula (1), R¹ and R² can be each independently a group selected from the group consisting of substituted or non-substituted, aliphatic hydrocarbon group having 1 to 10 carbon atoms and aromatic hydrocarbon group having 6 to 20 carbon atoms, and x is an integer of 0 to 3. In the formula (1), R¹ and R² are preferably each independently a group selected from the group consisting of substituted or non-substituted, aliphatic hydrocarbon group having 1 to 5 carbon atoms and aromatic hydrocarbon group having 6 to 10 carbon atoms, more preferably each independently a group selected from the group consisting of a methyl group, an ethyl group, a propyl group and a phenyl group.

Herein, “substituted” means that a hydrogen atom is substituted with any other group. Examples of the above group can include a methyl group, an ethyl group, a propyl group, and a butyl group, but not limited thereto.

In the formula (1), x is an integer of 0 to 3. In a case where the alkoxysilane compound represented by the formula (1) is used singly, x is preferably an integer of 0 to 2, more preferably 1 or 2. In a case where two or more such alkoxysilane compounds are used, combination use of at least a first alkoxysilane compound in which x is an integer of 1 to 3 and a second alkoxysilane compound in which x is an integer of 0 to 3 is preferred (except for a mode in which both the first alkoxysilane compound and the second alkoxysilane compound satisfy x=3).

The component (A) used in the present invention is a silicone oligomer having only an alkoxy group, a phenyl group and an alkyl group in its molecule. In other words, the component (A) is a silicone oligomer certainly having an alkoxy group, a phenyl group and an alkyl group in its molecule. The component (A) is such a silicon oligomer and thus a cured product after curing and drying of the composition of the present invention is excellent in adhesiveness, in particular, adhesiveness against impact and/or bending, and weather resistance, is hardly cracked even if subjected to impact and/or the like, and has favorable scratch coverability. The component (A) is a partial hydrolytic condensate of an alkoxysilane compound which is a compound represented by the following formula (2):

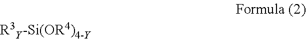

(in the formula (2), R³ is a phenyl group, R⁴ is an alkyl group, and Y is an integer of 1 to 3), and an alkoxysilane compound which is a compound represented by the following formula (3):

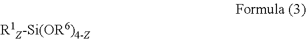

(in the formula (3), R⁵ and R⁶ are each an alkyl group and Z is an integer of 1 to 3). In one embodiment, the component (A) can be a silicon oligomer obtained from the alkoxysilane compounds represented by the formula (2) and formula (3) and a tetraalkoxysilane compound (alkoxysilane compound where, in the formula (1), R¹ and R² are each independently a substituted or non-substituted aliphatic hydrocarbon group having 1 to 10 carbon atoms, and x=0 is satisfied).

Furthermore, not only the alkoxysilane compounds represented by the formula (2) and formula (3), but also one or more alkoxysilane compounds each having both an alkyl group and a phenyl group and being a compound represented by the following formula (4):

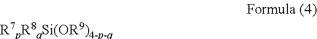

(in the formula (4), R⁷ is a phenyl group, R⁸ and R⁹ are each an alkyl group, p is an integer of 1 to 2, q is an integer of 1 to 2, and p+q≤3 is satisfied) may be used to synthesize a silicone oligomer as the component (A) by partial hydrolytic condensation. The component (A) is preferably a condensate of the alkoxysilane compound represented by the formula (2) and the alkoxysilane compound represented by the formula (3) from the viewpoint of flexibility, adhesiveness, and the like of a cured product. In one embodiment, the component (A) can be a silicone oligomer obtained from the formula (2), the formula (3), the formula (4), and a tetraalkoxysilane compound.

In one embodiment, R⁴ in the formula (2) can be each independently a methyl group, an ethyl group, a propyl group, or a butyl group, and is preferably a methyl group or an ethyl group, more preferably a methyl group from the viewpoint of curability.

In one embodiment, R⁵ and R⁶ in the formula (3) can be each independently a methyl group, an ethyl group, a propyl group, or a butyl group, and are preferably each independently a methyl group or an ethyl group and are more preferably methyl groups from the viewpoint of adhesiveness.

In one embodiment, examples of each alkoxy group contained in the tetraalkoxysilane compound for obtaining the component (A) include a methoxy group, an ethoxy group, a propoxy group, and a butoxy group, but not limited thereto. One or more, two or more, three or more, or all four alkoxy groups among four alkoxy groups contained in the tetraalkoxysilane compound for obtaining the component (A) can be each a methoxy group.

In one embodiment, R⁸ and R⁹ in the formula (4) can be each independently a methyl group, an ethyl group, a propyl group, or a butyl group, and are preferably each independently a methyl group or an ethyl group and both are more preferably methyl groups from the viewpoint of dry-through endurance, adhesiveness and the like.

The alkoxy group in the component (A) is preferably an alkoxy group having 1 to 5 carbon atoms, more preferably an alkoxy group having 1 to 3 carbon atoms, examples of the alkoxy group having 1 to 3 carbon atoms include methoxy group, an ethoxy group, and a propoxy group, and a methoxy group is preferred from the viewpoint of dry-through endurance of the composition, and flexibility, adhesiveness and the like of a cured product obtained by curing the composition.

The alkyl group in the component (A) is preferably an alkyl group having 1 to 5 carbon atoms, more preferably an alkyl group having 1 to 3 carbon atoms, examples of the alkyl group having 1 to 3 carbon atoms include a methyl group, an ethyl group, and a propyl group, but are not limited thereto, and a methyl group is preferred from the viewpoint of flexibility and adhesiveness.

The kinetic viscosity at 25° C. of the component (A) is preferably in the range of 1 to 500 mm²s⁻¹, more preferably 10 to 350 mm²s⁻¹, further preferably 15 to 300 mm²s⁻¹, still further preferably 30 to 280 mm²s⁻¹, particularly preferably 50 to 270 mm²s⁻¹. When the kinetic viscosity of the component (A) is 1 mm²s⁻¹ or more, a uniform film can be formed, and when the kinetic viscosity is 500 mm²s⁻¹ or less, workability is favorable. In a case where the kinetic viscosity of the component (A) is 50 mm²s⁻¹ or more, a cured product obtained from the composition of the present invention exhibits particularly excellent weather resistance and the cured product can be inhibited from being discolored. The kinetic viscosity is herein measured by a viscosity measurement method according to JIS Z 8803:2011. For example, the kinetic viscosity can be measured with a single cylinder-type rotational viscometer (B-type viscometer).

Examples of a commercially available product of the component (A) include, but not particularly limited, KR-401N, KR-510, KR-9218, X-40-9227, and X-40-9312 (manufactured by Shin-Etsu Chemical Co., Ltd.). These may be used singly or in combinations of two or more kinds thereof.

The content of the component (A) based on the entire of the composition can be 10% by mass or more, 15% by mass or more, or 20% by mass or more and can be 98% by mass or less, 50% by mass or less, or 40% by mass or less. The content of the component (A) based on the entire of the composition can be 10 to 98% by mass, 15 to 50% by mass, or 20 to 40% by mass. In a case where an organic solvent is included in the composition of the present invention, the content of the component (A) based on the entire of the composition excluding the organic solvent can be 80 to 98% by mass or 90 to 95% by mass. In a case where the content of the component (A) based on the entire of the composition excluding the organic solvent is 80 to 98% by mass, a cured product obtained from the composition of the present invention is excellent in flexibility and can be prevented from being cracked. In the case of use of two or more kinds, the content of the component (A) refers to the total value.

The component (B) used in the present invention is the compound having an alkoxy group and having an amino group and/or a mercapto group in its molecule. In one embodiment, the component (B) can be a compound having a silicon atom. In one embodiment, the component (B) can be a silane compound, and examples include a silane coupling agent having an alkoxy group and an amino group or a mercapto group at respective ends of a hydrocarbon chain. Examples of the silane compound usable as the component (B) include 3-mercaptopropylmethyldimethoxysilane, 3-mercaptopropyltrimethoxysilane, N-2-(aminoethyl)-3-aminopropylmethyldimethoxysilane, N-2-(aminoethyl)-3-aminopropyltrimethoxysilane, and 3-aminopropyltrimethoxysilane, but not limited thereto. The component (B) may or may not have a main chain structure, and even in a case where the component has a main chain structure, such a main chain structure is not particularly limited. The component (B) may also be a silicone oligomer having an alkoxy group and an amino group and/or a mercapto group in a side chain and at an end of a polysiloxane chain. In particular, a silane compound and/or a silicone oligomer each having an amino group are/is preferred and furthermore such a silicone oligomer is more preferred from the viewpoint of excellent drying properties.

The alkoxy group in the component (B) is preferably an alkoxy group having 1 to 10 carbon atoms, and can be more preferably an alkoxy group having 1 to 5 carbon atoms. Examples of the alkoxy group in the component (B) include a methoxy group, an ethoxy group, a propoxy group, and a butoxy group, but not limited thereto, and a methoxy group or an ethoxy group is preferred and a methoxy group is further preferred in terms of excellent long-term weather resistance. The component (B) may have, as a partial structure, an alkoxysilyl group (for example, a monoalkoxysilyl group, a dialkoxysilyl group, and a trialkoxysilyl group). The alkoxy group contained in the alkoxysilyl group can be the same as the alkoxy group in the component (B).

The component (B) may contain any one of or both an amino group and a mercapto group, and preferably contains a mercapto group in terms of excellent adhesiveness.

In one embodiment, the component (B) is preferably a silicone oligomer or silane compound having an alkyl group, more preferably a silicone oligomer having an alkyl group, further preferably a silicone oligomer having a methyl group. The component (B) has an alkyl group to allow a cured product obtained from the composition of the present invention to exhibit excellent adhesiveness and weather resistance.

Examples of a commercially available product of the component (B) include, but not particularly limited, KR-518, KR-519, KBM-573, KBM-603, KBM-803, and KBM-903 (manufactured by Shin-Etsu Chemical Co., Ltd.).

The content of the component (B) is preferably 0.1 to 15 parts by mass, further preferably 0.5 to 10 parts by mass, most preferably 0.5 to 5 parts by mass based on 100 parts by mass of the component (A). When the content is 0.1 parts by mass or more, adhesiveness is excellent, and when the content is 15 parts by mass or less, the influence on weather resistance is small. In the case of use of two or more kinds, the content of the component (B) refers to the total value.

The component (C) used in the present invention is a silicone oligomer having only an alkoxy group and an alkyl group in its molecule (except for the component (A)). In other words, the component (C) is a silicone oligomer certainly having an alkoxy group and an alkyl group in its molecule. The component (C) can be a condensate produced with one or more alkoxysilane compounds each being a compound represented by the following formula (5):

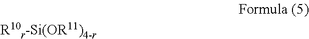

(in the formula (5), R¹⁰ and R¹¹ are each independently an alkyl group, for example, an alkyl group having 1 to 5 carbon atoms (saturated aliphatic hydrocarbon group), and r is an integer of 1 to 3). The compound represented by the formula (5) may be used singly or in combinations of a plurality thereof. The component (C) may also be a silicone oligomer obtained from the alkoxysilane compound represented by the formula (5), and a tetraalkoxysilane compound. Furthermore, the silicone oligomer used as the component (C) may be used singly or in combinations of two or more kinds thereof. Examples of R¹⁰ in the formula (5) include a methyl group, an ethyl group, a propyl group, and a butyl group, and the component (C) is preferably a silicone oligomer which is a condensate of an alkoxysilane compound, in which R¹⁰ can be a methyl group, from the viewpoint of adhesiveness.

The alkoxy group in the component (C) is preferably an alkoxy group having 1 to 5 carbon atoms, and can be more preferably an alkoxy group having 1 to 3 carbon atoms, example of the alkoxy group having 1 to 3 carbon atoms include a methoxy group, an ethoxy group, and a propoxy group, and a methoxy group is preferred from the viewpoint of dry-through endurance of the composition, adhesiveness of a cured product, and the like.

The alkyl group in the component (C) is preferably an alkyl group having 1 to 5 carbon atoms, and can be more preferably an alkyl group having 1 to 3 carbon atoms, examples of the alkyl group having 1 to 3 carbon atoms include a methyl group, an ethyl group, and a propyl group, and a methyl group is preferred from the viewpoint of adhesiveness of a cured product, and the like.

The kinetic viscosity at 25° C. of the component (C) is preferably in the range of 1 to 500 mm²s⁻¹, preferably 10 to 350 mm²s⁻¹, more preferably 40 to 200 mm²s⁻¹, further preferably 60 to 90 mm²s⁻¹. When the kinetic viscosity is 1 mm²s⁻¹ or more, a uniform film can be formed, and when the kinetic viscosity is 500 mm²s⁻¹ or less, workability is favorable.

Examples of a commercially available product of the component (C) include, but not particularly limited, KC-89S, KR-500, X-40-9225, X-40-9246, and X-40-9250 (manufactured by Shin-Etsu Chemical Co., Ltd.).

The content of the component (C) is preferably 0.1 to 15 parts by mass, further preferably 0.5 to 10 parts by mass, most preferably 0.5 to 5 parts by mass based on 100 parts by mass of the component (A). When the content is 0.1 parts by mass or more, a coating agent composition excellent in adhesiveness can be obtained, and when the content is 15 parts by mass or less, a coating agent composition which is excellent in flexibility and which causes no cracks can be obtained. In the case of use of two or more kinds, the content of the component (C) refers to the total value.

The component (D) used in the present invention is a curing catalyst. The component (D) is a compound for a condensation reaction by a reaction of an alkoxy group contained in the components (A) to (C) with moisture or the like in the air. The component (D) used here can be appropriately selected from conventionally known compounds, and can be a compound having required properties, selected from an organotin compound, an organozinc compound, an organotitanium compound, an organozirconium compound, an organoaluminum compound, an organonickel compound, an inorganic acid compound, an organic acid compound, an inorganic base compound, an organic base compound, and the like, from the viewpoint of reaction activity and storage stability, coloring ability, and the like. These may be used singly or in combinations of two or more kinds thereof.

Examples of the organotin compound include dibutyltin dilaurate, dibutyltin dioctate, dibutyltin diacetate, dioctyltin dilaurate, dioctyltin dioctate, dioctyltin diacetate, dibutyltin bisacetylacetate, and dioctyltin bisacetyllaurate.

Examples of the organozinc compound include zinc triacetylacetonate, zinc-2-ethylhexoate, zinc naphthenate, and zinc stearate.

Examples of the organotitanium compound include tetrabutyl titanate, tetranonyl titanate, tetrakisethylene glycol methyl ether titanate, tetrakisethylene glycol ethyl ether titanate, and bis(acetylacetonyl) dipropyl titanate.

Examples of the organozirconium compound include zirconium tetraacetylacetonate, zirconium tributoxyacetylacetonate, zirconium dibutoxydiacetylacetonate, zirconium tetra-normal-propoxide, zirconium tetraisopropoxide, zirconium tetra-normal-butoxide, zirconium acylate, zirconium tributoxy stearate, zirconium octoate, zirconyl (2-ethylhexanoate), and zirconium (2-ethylhexoate).

Examples of the organoaluminum compound include aluminum salt compounds such as aluminum octylate, aluminum triacetate and aluminum tristearate, aluminum alkoxide compounds such as aluminum trimethoxide, aluminum triethoxide, aluminum triallyloxide and aluminum triphenoxide, and aluminum chelate compounds such as aluminum methoxybis(ethylacetoacetate), aluminum methoxybis(acetylacetonate), aluminum ethoxybis(ethylacetoacetate), aluminum ethoxybis(acetylacetonate), aluminum isopropoxybis(ethylacetoacetate), aluminum isopropoxybis(methylacetoacetate), aluminum isopropoxybis(t-butylacetoacetate), aluminum butoxybis(ethylacetoacetate), aluminum dimethoxy(ethylacetoacetate), aluminum dimethoxy(acetylacetonate), aluminum diethoxy(ethylacetoacetate), aluminum diethoxy(acetylacetonate), aluminum diisopropoxy(ethylacetoacetate), aluminum diisopropoxy(methylacetoacetate), aluminum tris(ethylacetoacetate), aluminum tris(acetylacetonate) and aluminum octylacetoacetate diisopropylate.

The component (D) used here is preferably a curing catalyst other than the organotin compound from the viewpoint of laws and regulations, and in particular, a metal alkoxide is preferred, titanium alkoxide is more preferred and tetrabutyl titanate is most preferred from the viewpoint that both curability and storability can be satisfied.

The content of the component (D) based on 100 parts by mass of the component (A) is preferably 0.1 to 20 parts by mass, further preferably 0.5 to 15 parts by mass, most preferably 1 to 10 parts by mass. When the content is 0.1 parts by mass or more, a coating agent composition excellent in curability can be obtained, and when the content is 20 parts by mass or less, a coating agent composition excellent in storage stability can be obtained. In the case of use of two or more kinds, the content of the component (D) refers to the total value.

The coating agent composition of the present invention preferably includes an organic solvent from the viewpoint of workability and coatability. An organic solvent is included to enable the components (A) to (D) to be uniformly dissolved or dispersed and also enable a homogeneous thin film to be formed by dilution. The organic solvent is not particularly limited as long as it is a liquid substance at 25° C. in which the components (A) to (D) can be uniformly dissolved or dispersed and which does not react with the components (A) to (D), and examples include a naphthene-based hydrocarbon and its halogenated product, a paraffin-based hydrocarbon and its halogenated product, an isoparaffin-based hydrocarbon and its halogenated product, an ether compound, an alcohol compound, a phenol compound, a glycol compound, a ketone compound, an ester compound, and a crude oil fractionation component. In a case where a substance formed from a compound easily absorbing water in the system, such as a low-molecular alcohol or ether, or acetone is selected, one is desirably used from which the water content is removed as much as possible by purification with distillation or the like.

Example of the organic solvent preferably include a ketone compound, an ester compound, an ether compound, an alcohol compound, a paraffin, isoparaffin or naphthene-based hydrocarbon compound, or a crude oil fractionation component, more preferably a paraffin, isoparaffin or naphthene-based hydrocarbon compound, or a crude oil fractionation component. In one embodiment, the organic solvent is preferably a linear or branched saturated hydrocarbon having 5 to 15 carbon atoms, more preferably a linear or branched saturated hydrocarbon having 6 to 14 carbon atoms, further preferably a branched saturated hydrocarbon having 6 to 14 carbon atoms. In particular, 2,2,4,6,6-pentamethylheptane can be suitably used as the organic solvent from the viewpoint of workability and coatability.

The content of the organic solvent based on the total amount of the coating agent composition is preferably 50 to 90% by mass, further preferably 60 to 80% by mass, most preferably 65 to 75% by mass. When the content is 50% by mass or more, a coating agent composition excellent in workability and coatability can be obtained, and when the content is 90% by mass or less, a coating agent composition excellent in scratch coverability can be obtained. In the case of use of two or more kinds, the content of the organic solvent refers to the total value.

In addition to the above components, any additive can be, if necessary, added as an optional component to the coating agent composition of the present invention as long as the effects of the present invention are not impaired. Examples of such an additive can include a silane coupling agent (excluding the component (B)), a plasticizer, a filler, a storage stabilizer, a tackifier, an organic or inorganic pigment, a rust inhibitor, a defoamer, a dispersant, a surfactant, a viscoelasticity preparation agent, and a thickener.

The method for preparing the coating agent composition of the present invention is not particularly limited, and a conventionally known method can be appropriately adopted. For example, the component (A), the component (B), the component (C), the component (D), and a component optionally added are weighed in respective predetermined amounts and sequentially or simultaneously added to a stirring oven regardless of the order, and thereafter mixed by use of a mixing unit such as a three-one motor preferably with being defoamed in vacuum. The order of addition is preferably set so that the component (D) is finally added. The component (D) can be finally added to prevent a curing reaction from progressing at an undesired stage. The mixing temperature is preferably a temperature of 10 to 50° C., and the mixing time is preferably 0.1 to 5 hours.

The method for coating with the coating agent composition of the present invention is not particularly limited, and a known procedure can be used. Examples include hand painting or brush painting with a fiber impregnated with the composition, and mechanical coating by use of an automatic machine. Preferably, a proper amount of a dry fiber such as a sponge or a waste cloth is impregnated with the coating agent composition according to the present invention, the coating agent composition with which the fiber is impregnated is thinly spread and extended onto a surface of a steel sheet or a painted sheet, by hand, to sublimate a volatile component by natural drying or forced drying with a drying machine or the like. Here, the components (A) to (C) as reactive components included in the coating agent composition are contacted with moisture in the air and proceed to a hydrolysis reaction with the action of the component (D), and are crosslinked and cured on a steel sheet or a painted sheet in parallel with sublimation of a volatile component, to form a cured product. In one embodiment, such a cured product obtained by curing the coating agent composition may be one in which one portion of the organic solvent is not volatilized and remains.

The coating agent composition subjected to coating by the above coating method is preferably provided so as to have a film thickness after drying of 1 to 15 μm. The film thickness is further preferably 2 to 10 μm, most preferably 4 to 7 μm. If the film thickness is 1 μm or more, scratch coverability are excellent, and if the film thickness is 15 μm or less, cracking of a coating film due to impact and/or bending does not occur.

The coating agent composition of the present invention can be applied onto any of various substrate such as a metal, glass, ceramics, a resin, and a colored steel sheet. The coating agent composition is in particular excellent in adhesiveness against impact and has coverability of a scratch, and therefore is suitable for those to be placed in the outdoor, such as a signboard, a signage, and an automatic vending machine. In one aspect of the present invention, the coating agent composition is applied, and an outdoor installation object coated with a cured product of the composition is also provided.

Embodiments of the present invention are described in detail, but it is clear that this description is explanatory and illustrative and is not limiting and the gist of the present invention is to be interpreted by the accompanied claims.

### EXAMPLES

Next, the present invention is further specifically described with reference to Examples, but the present invention is not limited to only these Examples. Unless particularly indicated, each test was carried out under an environment at 25° C. and 55% RH.

### Examples 1 to 7 and Comparative Examples 1 to 9

The following components were prepared in order to each coating agent composition. Hereinafter, the coating agent composition is also simply called composition.

### Component (A): Silicone Oligomer Having Only Alkoxy Group, Phenyl Group and Alkyl Group in its Molecule

X-40-9312 (a silicone oligomer having a methoxy group, a methyl group and a phenyl group, kinetic viscosity: 250 mm²s⁻¹, manufactured by Shin-Etsu Chemical Co., Ltd.)
X-40-9227 (a silicone oligomer having a methoxy group, a methyl group and a phenyl group, kinetic viscosity: 15 mm²s⁻¹, manufactured by Shin-Etsu Chemical Co., Ltd.)
KR-401N (a silicone oligomer having a methoxy group, a methyl group and a phenyl group, kinetic viscosity: 20 mm²s⁻¹, manufactured by Shin-Etsu Chemical Co., Ltd.)
KR-9218 (a silicone oligomer having a methoxy group, a methyl group and a phenyl group, kinetic viscosity: 40 mm²s⁻¹, manufactured by Shin-Etsu Chemical Co., Ltd.)
   Component (A′) or Component (C): A Silicone Oligomer Other than the Component (A)
KC-89S (a silicone oligomer having a methoxy group and a methyl group, kinetic viscosity: 5 mm²s⁻¹, manufactured by Shin-Etsu Chemical Co., Ltd.)
X-40-9225 (a silicone oligomer having a methoxy group and a methyl group, kinetic viscosity: 100 mm²s⁻¹, manufactured by Shin-Etsu Chemical Co., Ltd.)
X-40-9246 (a silicone oligomer having a methoxy group and a methyl group, kinetic viscosity: 80 mm²s⁻¹, manufactured by Shin-Etsu Chemical Co., Ltd.)
   Component (A′): Silicone Oligomer Other than Component (A)
KR-516 (a silicone oligomer having a methoxy group, a methyl group and an epoxy group, kinetic viscosity: 50 mm²s⁻¹, manufactured by Shin-Etsu Chemical Co., Ltd.)
   Component (B): Compound Having, in its Molecule, Alkoxy Group as Well as at Least One Functional Group Selected from the Group Consisting of Amino Group and Mercapto Group (Excluding Component (A))
KR-519 (a silicone oligomer having a methoxy group, a methyl group and a mercapto group, manufactured by Shin-Etsu Chemical Co., Ltd.)
KR-518 (a silicone oligomer having a methoxy group, an ethoxy group and a mercapto group, manufactured by Shin-Etsu Chemical Co., Ltd.)
KBM-803 (3-mercaptopropyltrimethoxysilane; a silane compound having a methoxy group and a mercapto group)
KBM-603 (N-2-(aminoethyl)-3-aminopropyltrimethoxysilane; a silane compound having a methoxy group and an amino group)

### Component (B′): Silane Compound not Containing at Least One of Amino Group and Mercapto Group

X-40-9296 (a silicone oligomer having a methoxy group, a methyl group and a methacrylic group, manufactured by Shin-Etsu Chemical Co., Ltd.)
KR-511 (a silicone oligomer having a methoxy group, a phenyl group and a vinyl group, manufactured by Shin-Etsu Chemical Co., Ltd.)
KR-513 (a silicone oligomer having a methoxy group, a methyl group and an acrylic group, manufactured by Shin-Etsu Chemical Co., Ltd.)
X-41-1059A (a silicone oligomer having a methoxy group, an ethoxy group and an epoxy group, manufactured by Shin-Etsu Chemical Co., Ltd.)

### Component (C): Silicone Oligomer Having Only Alkoxy Group and Alkyl Group in its Molecule (Excluding Component (A) and Component (B))

X-40-9250 (a silicone oligomer having a methoxy group and a methyl group, kinetic viscosity: 80 mm²s⁻¹, manufactured by Shin-Etsu Chemical Co., Ltd.))

### Component (D): Curing Catalyst

tetrabutyl titanate

### Organic Solvent

2,2,4,6,6-pentamethylheptane (an isoparaffin-based hydrocarbon compound)

The method for producing the composition according to each of Examples 1 to 7 and Comparative Examples 1 to 9 is as follows. The components (A) to (D), and the organic solvent were weighed and stirred with a three-one motor manufactured by Shinto Scientific Co., Ltd., for 15 minutes, to obtain each coating agent composition. The detailed amount of preparation is according to Table 1 and Table 2, and all numerical values are expressed by “parts by mass”.

### <Drying Time (Min)>

Tissue paper was infiltrated with 2 ml of the composition. Next, coating was uniformly performed with the tissue paper so that the thickness of a dried coating film was about 5 μm on the entire of a white painted surface of a white painted sheet (material: SPCC-SD (cold-rolled steel sheet), standard: JIS G 3141:2017, dimension: 0.8 mm×70 mm×150 mm, obtained by white painting of one surface with aminoalkyd after chemical electrodeposition, no clear coat, manufactured by Asahi-Betechno Co., Ltd.), and the resultant was adopted as a test piece (herein, “dried coating film” referring to a film-shaped cured product of the composition, and also simply referring to “coating film”). Thereafter, the test piece was perpendicularly set against a wall so that a longer side was longitudinal and disposed on a seating, and left to still stand under an environment at 25° C. and 55% RH, and the time until drying was measured to perform a test of dry-through endurance. After a surface to be coated of the test piece located above the seating by 1 cm or more was coated with the composition, a different surface to be coated was subjected to measurement at an interval of 1 minute, to evaluate drying properties (namely, referring to “dry-through endurance”, and herein “curing and drying” also being simply referred to “drying”). The drying time was measured according to JIS K 5600-3-3:1999. Whether or not the dried state was achieved was determined by a method according to a dry to touch test according to JIS K 5600-1-1:1999. The drying time is preferably 60 minutes or less, more preferably 30 minutes or less, particularly preferably 25 minutes or less.

### <Tape Peeling Test>

A white painted sheet was coated with the composition by the same procedure as in the drying time measurement. The resultant was left to still stand under drying conditions of an environment at 25° C. and 55% RH for 24 hours. A pressure-sensitive adhesive tape (cellophane tape manufactured by NICHIBAN Co., Ltd.) of about 3 cm is attached within 1 cm inside on a surface of the coating film of the test piece produced. Thereafter, the pressure-sensitive adhesive tape was peeled, and whether or not the coating film was peeled from the white painted sheet by the pressure-sensitive adhesive tape was confirmed by visually observing the white painted sheet, based on the following evaluation criteria.

### Evaluation Criteria

Good: not peeled
Poor: peeled.

### <Scratch Coverability Test>

A black painted surface of a black painted sheet (material: SPCC-SD (cold-rolled steel sheet), standard: JIS G 3141:2017, dimension: 0.8 mm×70 mm×150 mm, obtained by black painting of one surface with aminoalkyd after chemical electrodeposition, clear coat, manufactured by Asahi-Betechno Co., Ltd.) is scratched by sandpaper of #40. A position scratched is washed with an alcohol and dried, and thereafter the position scratched is coated with the composition, according to the same procedure as in the drying time measurement, and dried under an environment at 25° C. and 55% RH for 24 hours. After aging, the test piece is set against a wall so that a longer side was longitudinal and perpendicular, and a scratch formed on the test piece is visually confirmed from a location apart by 1 m from the test piece, based on the following evaluation criteria. Such a scratch is allowed to disappear and thus design is also excellent.

### Evaluation Criteria

Good: scratch found
Poor: no scratch found.

### <Impact Peeling Test>

A steel sheet (SPCC-SD (cold-rolled steel sheet), standard: JIS G 3141:2017, dimension: 0.8 mm×70 mm×150 mm) was used and coating with the composition was made by the same procedure as in the drying time measurement. The resultant is left to still stand under drying conditions of an environment at 25° C. and 55% RH for 24 hours. A surface to be coated of the test piece produced was subjected to a falling-weight test with a Dupont impact tester manufactured by Tester Sangyo Co., Ltd., and the coating film was visually confirmed based on the following evaluation criteria. The test was performed at a height of the weight of 500 mm and a mass of the weight of 500 g. The detailed test method is according to JIS K 5600 May 3:1999.

### Evaluation Criteria

Good: no peeling and no cracking of the coating film
Poor: peeling or cracking of the coating film being confirmed.

### <Bending Test>

A test piece was made by the same procedure as in the impact peeling test. The test piece is left to still stand under drying conditions of an environment at 25° C. and 55% RH for 24 hours. The test piece produced was subjected to a mandrel bending test with a mandrel bending tester manufactured by Ueshima Seisakusho Co., Ltd., and the coating film was confirmed according to the following evaluation criteria. The diameter of the mandrel used is a diameter of ⅜ inches. The detailed test method is according to JIS K 5600-5-1:1999.

### Evaluation Criteria

Good: no peeling and no cracking of the coating film
Poor: peeling or cracking of the coating film being confirmed.

### <Weather Resistance Test>

A white painted sheet was coated with the composition by the same procedure as in the drying time measurement. The resultant is left to still stand under drying conditions of an environment at 25° C. and 55% RH for 24 hours. A test piece produced was subjected to an accelerated weather resistance test with a xenon weather meter NX75 manufactured by Suga Test Instruments Co., Ltd., and the coating film after 1000 hours and that after 2000 hours were confirmed according to the following evaluation criteria. The detail of the tester is according to JIS B 7754:1991, and the test method is according to JIS D 0205:1987.

### Evaluation Criteria

Excellent: no peeling and no cracking of the coating film after 2000 hours
Good: no peeling and no cracking of the coating film after 1000 hours (excluding the case of Excellent)
Poor: peeling or cracking of the coating film being confirmed after 1000 hours.

TABLE 1

| | | Example | Example | Example | Example | Example | Example | Example |
|---|---|---|---|---|---|---|---|---|
| | | 1 | 2 | 3 | 4 | 5 | 6 | 7 |
| Component (A) | X-40-9312 | 100 | | | | 100 | 100 | 100 |
| | X-40-9227 | | 100 | | | | | |
| | KR-401N | | | 100 | | | | |
| | KR-9218 | | | | 100 | | | |
| Component | KC-89S | | | | | | | |
| (A′)/Component | X-40-9225 | | | | | | | |
| (C) | X-40-9246 | | | | | | | |
| Component (A′) | KR-516 | | | | | | | |
| Component (B) | KR-519 | 1.5 | 1.5 | 1.5 | 1.5 | | | |
| | KR-518 | | | | | 1.5 | | |
| | KBM-803 | | | | | | 1.5 | |
| | KBM-603 | | | | | | | 1.5 |
| Component (B′) | X-40-9296 | | | | | | | |
| | KR-511 | | | | | | | |
| | KR-513 | | | | | | | |
| | X-41-1059A | | | | | | | |
| Component (C) | X-40-9250 | 1.5 | 1.5 | 1.5 | 1.5 | 1.5 | 1.5 | 1.5 |
| Component (D) | Tetrabutyl titanate | 5 | 5 | 5 | 5 | 5 | 5 | 5 |
| Organic solvent | 2,2,4,6,6- | 272 | 272 | 272 | 272 | 272 | 272 | 272 |
| | Pentamethylbutane | | | | | | | |

| | | | | | | | |
|---|---|---|---|---|---|---|---|
| Total | 380 | 380 | 380 | 380 | 380 | 380 | 380 |
| Drying time (min) | 25 | 25 | 25 | 25 | 25 | 32 | 28 |
| Tape peeling test | Good | Good | Good | Good | Good | Good | Good |
| Scratch coverability test | Good | Good | Good | Good | Good | Good | Good |
| Impact peeling test | Good | Good | Good | Good | Good | Good | Good |
| Bending test | Good | Good | Good | Good | Good | Good | Good |
| Weather resistance test | Excellent | Excellent | Excellent | Excellent | Good | Good | Good |

TABLE 2

| | | Compar- | Compar- | Compar- | Compar- | Compar- | Compar- | Compar- | Compar- | Compar- |
|---|---|---|---|---|---|---|---|---|---|---|
| | | ative | ative | ative | ative | ative | ative | ative | ative | ative |
| | | Example 1 | Example 2 | Example 3 | Example 4 | Example 5 | Example 6 | Example 7 | Example 8 | Example 9 |
| Component (A) | X-40-9312 | | | | | | 100 | 100 | 100 | 100 |
| | X-40-9227 | | | | | | | | | |
| | KR-401N | | | | | | | | | |
| | KR-9218 | | | | | | | | | |
| Component | KC-89S | 100 | | | | | | | | |
| (A′)/Component | X-40-9225 | | 100 | | | | | | | |
| (C) | X-40-9246 | | | 100 | | | | | | |
| Component (A′) | KR-516 | | | | 100 | | | | | |
| Component (B) | KR-519 | 1.5 | 1.5 | 1.5 | 1.5 | 1.5 | | | | |
| | KR-518 | | | | | | | | | |
| | KBM-803 | | | | | | | | | |
| | KBM-603 | | | | | | | | | |
| Component (B′) | X-40-9296 | | | | | | 1.5 | | | |
| | KR-511 | | | | | | | 1.5 | | |
| | KR-513 | | | | | | | | 1.5 | |
| | X-41-1059A | | | | | | | | | 1.5 |
| Component (C) | X-40-9250 | 1.5 | 1.5 | 1.5 | 1.5 | 101.5 | 1.5 | 1.5 | 1.5 | 1.5 |
| Component (D) | Tetrabutyl titanate | 5 | 5 | 5 | 5 | 5 | 5 | 5 | 5 | 5 |
| Organic solvent | 2,2,4,6,6- | 272 | 272 | 272 | 272 | 272 | 272 | 272 | 272 | 272 |
| | Pentamethylbutane | | | | | | | | | |

| | | | | | | | | | |
|---|---|---|---|---|---|---|---|---|---|
| Total | 380 | 380 | 380 | 380 | 380 | 380 | 380 | 380 | 380 |
| Drying time (min) | 25 | 25 | 25 | 25 | 25 | 25 | 29 | 30 | 31 |
| Tape peeling test | Good | Good | Good | Good | Good | Poor | Poor | Poor | Poor |
| Scratch coverability test | Good | Good | Good | Good | Good | Good | Good | Good | Good |
| Impact peeling test | Poor | Poor | Good | Poor | Good | Good | Good | Good | Good |
| Bending test | Poor | Good | Good | Poor | Poor | Good | Good | Good | Good |
| Weather resistance test | Poor | Good | Poor | Good | Good | Excellent | Excellent | Excellent | Excellent |

It was confirmed that Examples 1 to 7 which each corresponded to a composition including the components (A) to (D) exhibited excellent scratch coverability and adhesiveness and also excellent weather resistance. It was further confirmed that a composition with a silicone oligomer as the component (B) was more excellent also in terms of the drying time. On the other hand, Comparative Examples 1 to 3 which each corresponded to a composition including the component (A′) (or component (C)) instead of the component (A), and Comparative Example 4 which corresponded to a composition including the component (A′) instead of the component (A) exhibited inferior impact resistance and bending resistance, and sometimes caused the occurrence of peeling due to deformation of a coating in the weather resistance test. The composition of Comparative Example 5, which also contained no component (A), was inferior in adhesiveness in the bending test and was confirmed to cause a coating film to be peeled. Comparative Examples 6 to 9, which each corresponded to a composition including the component (B′) instead of the component (B), were each confirmed to cause a coating film to be peeled and/or floated in the tape peeling test, and resulted in inferior adhesiveness with the painted sheet. It was further confirmed that, in Examples 1 and 5 to 7, no discoloration was observed in a coating film even after 2000 hours in the accelerated weather resistance test and excellent weather resistance was exhibited.

### INDUSTRIAL APPLICABILITY

The coating agent composition of the present invention is excellent in adhesiveness and in particular excellent in adhesiveness against impact and/or bending, and thus can be applied onto various substrates such as metals, glass, ceramics, and resins. Furthermore, the coating agent composition has coverability of a scratch, and therefore is suitable for those to be placed in the outdoor, such as signboards, signages, and automatic vending machines.

The present application is based on Japanese Patent Application No. 2022-162524 filed on Oct. 7, 2022, the content of which is herein incorporated by reference in its entirety.

1. A coating agent composition comprising the following components (A) to (D):
component (A): a silicone oligomer having only an alkoxy group, a phenyl group and an alkyl group in its molecule;
component (B): a compound having an alkoxy group and having an amino group and/or a mercapto group in its molecule;
component (C): a silicone oligomer having only an alkoxy group and an alkyl group in its molecule; and
component (D): a curing catalyst.

2. The coating agent composition according to claim 1, wherein the alkyl group in the component (A) is a methyl group.

3. The coating agent composition according to claim 1, wherein the alkoxy group in the component (A) is a methoxy group.

4. The coating agent composition according to claim 1, wherein the component (B) is a silicone oligomer having an alkoxy group and having an amino group and/or a mercapto group in its molecule.

5. The coating agent composition according to claim 1, wherein a content of the component (B) is 0.1 to 15 parts by mass based on 100 parts by mass of the component (A).

6. The coating agent composition according to claim 1, wherein a content of the component (C) is 0.1 to 15 parts by mass based on 100 parts by mass of the component (A).

7. The coating agent composition according to claim 1, wherein the component (D) is metal alkoxide.

8. The coating agent composition according to claim 1, further comprising an organic solvent.

9. An outdoor installation object coated with a cured product of the coating agent composition according to claim 1.
